(19) United States
(12) Patent Application Publication
(10) Pub. No.: US 2024/0430763 A1
(43) Pub. Date: Dec. 26, 2024

(54) UL SYNCRONIZATION RECOVERY AT BEAM CHANGE

(71) Applicant: Nokia Technologies Oy, Espoo (FI)

(72) Inventors: Lars DALSGAARD, Oulu (FI); Dimitri GOLD, Espoo (FI)

(21) Appl. No.: 18/698,639

(22) PCT Filed: Oct. 12, 2022
(86) PCT No.: PCT/EP2022/078331

§ 371 Date: Apr. 4, 2024

Related U.S. Application Data
(60) Provisional application No. 63/275,709, filed on Nov. 4, 2021.

(51) Int. Cl. H04W 36/06; H04B 7/0408; H04W 74/0833; H04W 88/08

(52) U.S. Cl. CPC H04W 36/06; H04B 7/0408; H04W 74/0833; H04W 88/085

(57) ABSTRACT

Disclosed in a mechanism for a user equipment connected to a base station via a first beam, to determine that a beam switch is to be performed from the first beam to a second beam, wherein the base station manages both the first and second beams and to perform the beam switch at least by a random-access procedure using the second beam to synchronize communications between the user equipment and the second beam.

### TECHNICAL FIELD

Exemplary embodiments herein relate generally to wireless communications and, more specifically, relates to synchronization between beams during handover from one cell to another in a cellular network.

### BACKGROUND

RAN4 is working on a work item related to defining requirements and UE (user equipment) behavior for High-Speed Train (HST) deployments using higher frequencies (currently discussing NR FR2, new radio frequency range #2).

The basic deployment scenarios have been agreed upon, and include, among others, e.g., a unidirectional deployment where the gNBs (base stations for NR) are located along the train track with the downlink beams pointing in one direction either towards or away from the train's movement direction. A common understanding is that each gNB will have multiple Remote Radio Heads (RRHs) connected for cost-optimized deployments.

The RRHs create individual beams that are used for communication with UEs, including train-mounted UEs referred to as Customer Premises Equipment (CPE). These beams create corresponding cells, which means the UEs will be handed over from cell to cell as the train moves. Handover involves synchronization between the UE and the cells, and synchronization recovery during or after handover, particularly in UL (uplink, from the UE to the gNB) can be an issue.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

According to a first example embodiment of the present invention, a method for a user equipment connected to a base station via a first beam, comprises: determining by the user equipment that a beam switch is to be performed from the first beam to a second beam, wherein the base station manages both the first and second beams; and performing by the user equipment the beam switch at least by performing a random-access procedure using the second beam to synchronize communications between the user equipment and the second beam.

In further refinements of the first example embodiment, the user equipment is configured to always initiate the random-access procedure for every beam switch between beams where a base station manages both beams. The user equipment is configured to initiate the random-access procedure based on one or more conditions. The user equipment is configured to initiate the random-access procedure based on one or more conditions being fulfilled. The one or more conditions being fulfilled comprise a downlink propagation delay that exceeds a threshold. Performing the random-access procedure using the second beam to synchronize communications is performed based on the one or more conditions being fulfilled and a beam switch is performed from the first to second beam without using the random-access procedure based on the one or more conditions not being fulfilled. The one or more conditions being fulfilled comprise a determination the second beam or downlink reference signal corresponding to the second beam indicated the second beam is not collocated with the serving beam. Furthermore, the determining that a beam switch is to be performed and the performing the beam switch are performed in response to reception by the user equipment of an indication that the random-access procedure is to be used for any beam switch that is to be performed from the first beam to a second beam where a base station manages both the first and second beams. The user equipment is configured with a first set of beams containing only the first beam, the determining by the user equipment that a beam switch is to be performed from the first beam to the second beam is in response to a reference signal for the first beam being determined to indicate a beam failure and the performing by the user equipment the beam switch comprises performing, because the first set contains only the first beam, the random-access procedure using the second beam based on the beam failure. The user equipment is configured with a second set of beams containing the second beam and the method further comprises identifying by the user equipment link recovery candidate beams using the second set at least by searching secondary synchronization signal corresponding to the beams in the second set and selecting the second cell based on the search. The searching secondary synchronization signal corresponding to the beams in the second set is performed in one direction relative to the orientation of the user equipment. The second set contains a few beams, of which one is the second beam, and the base station manages the few beams.

According to a second example embodiment of the present invention, a method for a base station that manages both first and second beams for a user equipment connected to the base station, comprises: setting configuration for the user equipment so that, when a beam switch is to be performed from the first beam to the second beam by the user equipment, the user equipment uses a random-access procedure for the beam switch and performing, responsive to the beam switch, a random-access procedure between the base station and user equipment using the second beam to synchronize communications between the user equipment and the second beam.

In further refinements of the second example embodiment, the configuration is to always initiate by the user equipment the random-access procedure for every beam switch between beams where a base station manages both beams. The configuration is to initiate by the user equipment the random-access procedure based on one or more conditions. The configuration is to initiate by the user equipment the random-access procedure based on the one or more conditions being fulfilled. The one or more conditions being fulfilled comprise a downlink propagation delay that exceeds a threshold. Performing the random-access procedure using the second beam to synchronize communication is performed based on the one or more conditions being fulfilled and the configuration is to cause by the user equipment a beam switch to be performed from the first to second beam without using the random-access procedure based on the one or more conditions not being fulfilled. The one or more conditions being fulfilled comprise a determination the second beam or downlink reference signal corresponding to the second beam indicated the second beam is not collocated with the serving beam. The configuration comprises the random-access procedure is to be used by the user equipment for any beam switch that is to be performed from the first beam to a second beam where the base station manages both the first and second beams. Furthermore, the configuration comprises the random-access procedure is to be used by the user equipment for any beam switch that is to be performed from the first beam to a second beam where the base station manages both the first and second beams. The configuration configures the user equipment with a first set of beams containing only the first beam such that, because the first set contains only the first beam, the user equipment will determine the beam switch has to be performed to the second beam based on a determination of beam failure for the first beam. The configuration configures the user equipment with a second set of beams containing the second beam. The configuration configures the user equipment to search secondary synchronization signals corresponding to the beams in the second set in one direction relative to orientation of the user equipment and wherein the base station transmits synchronization signals on the second beam. The second set contains a few beams, of which one is the second beam, and wherein the base station transmits synchronization signals on the few beams.

According to a third example embodiment of the present invention, a computer program is provided, comprising code for performing the methods of the first and second example embodiments, when the computer program is run on a computer. The computer program is a computer program product comprising a computer-readable medium bearing computer program code embodied therein for use with the computer. The computer program being directly loadable into an internal memory of the computer.

According to a fourth example embodiment of the present invention, an apparatus for a user equipment connected to a base station via a first beam, comprises means for performing: determining by the user equipment that a beam switch is to be performed from the first beam to a second beam, wherein the base station manages both the first and second beams; and performing by the user equipment the beam switch at least by performing a random-access procedure using the second beam to synchronize communications between the user equipment and the second beam.

In further refinements of the fourth example embodiment, the user equipment is configured to always initiate the random-access procedure for every beam switch between beams where a base station manages both beams. The user equipment is configured to initiate the random-access procedure based on one or more conditions. The user equipment is configured to initiate the random-access procedure based on the one or more conditions being fulfilled. The one or more conditions being fulfilled comprise a downlink propagation delay that exceeds a threshold. Performing the random-access procedure using the second beam to synchronize communications is performed based on the one or more conditions being fulfilled and a beam switch is performed from the first to second beam without using the random-access procedure based on the one or more conditions not being fulfilled. The one or more conditions being fulfilled comprise a determination the second beam or downlink reference signal corresponding to the second beam indicated the second beam is not collocated with the serving beam. Determining that a beam switch is to be performed and the performing the beam switch are performed in response to reception by the user equipment of an indication that the random-access procedure is to be used for any beam switch that is to be performed from the first beam to a second beam where a base station manages both the first and second beams. Furthermore, the user equipment is configured with a first set of beams containing only the first beam, the determining by the user equipment that a beam switch is to be performed from the first beam to the second beam is in response to a reference signal for the first beam being determined to indicate a beam failure and the performing by the user equipment the beam switch comprises performing, because the first set contains only the first beam, the random-access procedure using the second beam based on the beam failure. The user equipment is configured with a second set of beams containing the second beam, and the means are further configured to perform identifying by the user equipment link recovery candidate beams using the second set at least by searching secondary synchronization signal corresponding to the beams in the second set and selecting the second cell based on the search. The searching secondary synchronization signal corresponding to the beams in the second set is performed in one direction relative to the orientation of the user equipment. The second set contains a few beams, of which one is the second beam, and the base station manages the few beams.

According to a fifth example embodiment of the present invention, an

apparatus for a base station that manages both first and second beams for a user equipment connected to the base station, comprises means for performing: setting configuration for the user equipment so that, when a beam switch is to be performed from the first beam to the second beam by the user equipment, the user equipment uses a random-access procedure for the beam switch and performing, responsive to the beam switch, a random-access procedure between the base station and user equipment using the second beam to synchronize communications between the user equipment and the second beam.

In further refinements of the fifth example embodiment, the configuration is to always initiate by the user equipment the random-access procedure for every beam switch between beams where a base station manages both beams. The configuration is to initiate by the user equipment the random-access procedure based on one or more conditions. The configuration is to initiate by the user equipment the random-access procedure based on one or more conditions being fulfilled. The one or more conditions being fulfilled comprise a downlink propagation delay that exceeds a threshold. Performing the random-access procedure using the second beam to synchronize communication is performed based on the one or more conditions being fulfilled and the configuration is to cause by the user equipment a beam switch to be performed from the first to second beam without using the random-access procedure based on the one or more conditions not being fulfilled. The one or more conditions being fulfilled comprise a determination the second beam or downlink reference signal corresponding to the second beam indicated the second beam is not collocated with the serving beam. The configuration comprises the random-access procedure is to be used by the user equipment for any beam switch that is to be performed from the first beam to a second beam where the base station manages both the first and second beams.

Furthermore, the configuration configures the user equipment with a first set of beams containing only the first beam such that, because the first set contains only the first beam, the user equipment will determine the beam switch has to be performed to the second beam based on a determination of beam failure for the first beam. The configuration configures the user equipment with a second set of beams containing the second beam. The configuration configures the user equipment to search secondary synchronization signals corresponding to the beams in the second set in one direction relative to the orientation of the user equipment and wherein the base station transmits synchronization signals on the second beam. The second set contains a few beams, of which one is the second beam, and wherein the base station transmits synchronization signals on the few beams. Furthermore, the means comprise: at least one processor and at least one memory including computer program code, the at least one memory and computer program code configured to, with the at least one processor, cause the performance of the apparatus.

According to a sixth example embodiment of the present invention, an apparatus for a user equipment connected to a base station via a first beam, comprises: one or more processors and one or more memories including computer program code, wherein the one or more memories and the computer program code are configured, with the one or more processors, to cause the apparatus to: determine by the user equipment that a beam switch is to be performed from the first beam to a second beam, wherein the base station manages both the first and second beams and perform by the user equipment the beam switch at least by performing a random-access procedure using the second beam to synchronize communications between the user equipment and the second beam.

According to a seventh example embodiment of the present invention, an apparatus for a base station that manages both first and second beams for a user equipment connected to the base station, comprises: one or more processors and one or more memories including computer program code, wherein the one or more memories and the computer program code are configured, with the one or more processors, to cause the apparatus to: set configuration for the user equipment so that, when a beam switch is to be performed from the first beam to the second beam by the user equipment, the user equipment uses a random-access procedure for the beam switch and perform, responsive to the beam switch, a random-access procedure between the base station and user equipment using the second beam to synchronize communications between the user equipment and the second beam.

According to an eighth example embodiment of the present invention, a computer program product for a user equipment connected to a base station via a first beam, is provided, comprising a computer-readable storage medium bearing computer program code embodied therein for use with a computer, the computer program code comprising: determining by the user equipment that a beam switch is to be performed from the first beam to a second beam, wherein the base station manages both the first and second beams and performing by the user equipment the beam switch at least by performing a random-access procedure using the second beam to synchronize communications between the user equipment and the second beam.

According to a ninth example embodiment of the present invention, a computer program product for a base station that manages both first and second beams for a user equipment connected to the base station, is provided, comprising a computer-readable storage medium bearing computer program code embodied therein for use with a computer, the computer program code comprising: setting configuration for the user equipment so that, when a beam switch is to be performed from the first beam to the second beam by the user equipment, the user equipment uses a random-access procedure for the beam switch and performing, responsive to the beam switch, a random-access procedure between the base station and user equipment using the second beam to synchronize communications between the user equipment and the second beam.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 is an illustration of a unidirectional FR2 HST scenario;

FIG. 3 illustrates an L3 mobility measurement model;

FIG. 4 is a signaling diagram for a scheme of RAN HO procedure;

FIG. 5 illustrates a scheme of beam/TCI state switching procedure;

FIG. 6 provides an illustration of the HST FR2 scenario with timing advance, where consecutive UE positions and corresponding TAs are shown;

FIG. 7 is a signaling diagram and flowchart for UL synchronization recovery at beam change for a specified method, in accordance with an exemplary embodiment;

FIG. 8 is a signaling diagram and flowchart for UL synchronization recovery at beam change for a network implementation method, in accordance with an exemplary embodiment;

FIG. 9 is a logic flow diagram performed by a UE for UL synchronization recovery at beam change, and illustrates the operation of an exemplary method, a result of execution of computer program instructions embodied on a computer readable memory, functions performed by logic implemented in hardware, and/or interconnected means for performing functions in accordance with an exemplary embodiment; and

FIG. 10 is a logic flow diagram performed by a base station for UL

synchronization recovery at beam change, and illustrates the operation of an exemplary method, a result of execution of computer program instructions embodied on a computer readable memory, functions performed by logic implemented in hardware, and/or interconnected means for performing functions in accordance with an exemplary embodiment.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The exemplary embodiments herein describe techniques for UL synchronization recovery at beam change. Additional description of these techniques is presented after a system into which the exemplary embodiments may be used is described.

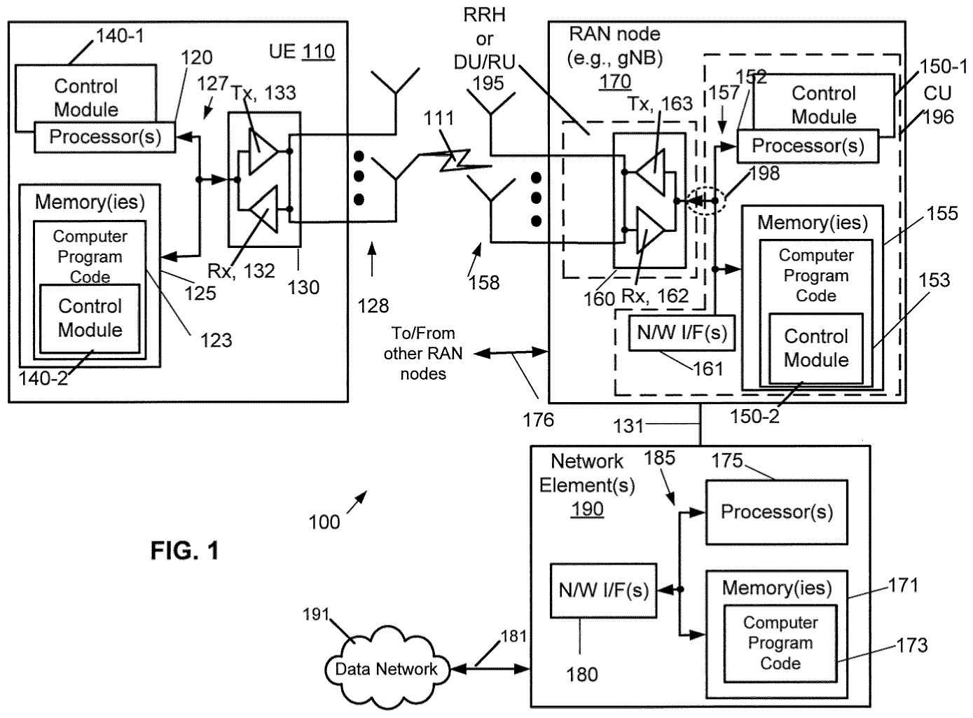

Turning to FIG. 1, this figure shows a block diagram of one possible and non-limiting exemplary system in which the exemplary embodiments may be practiced. A user equipment (UE) 110, radio access network (RAN) node 170, and network element(s) 190 are illustrated. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 is a base station that provides access by wireless devices such as the UE 110 to the wireless network 100. The RAN node 170 may be, for instance, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (e.g., the network element(s) 190). The ng-eNB is a node providing E-UTRA user plane and control plane protocol terminations towards the UE, and connected via the NG interface to the 5GC. The NG-RAN may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-DU supports one or multiple cells. One cell is supported by one gNB-DU. The gNB-DU terminates the F1 interface 198 connected with the gNB-CU. Note that the DU 195 is considered to include the transceiver 160, e.g., as part of an RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a control module 150, comprising one of or both parts 150-1 and/or 150-2, which may be implemented in a number of ways. The control module 150 may be implemented in hardware as control module 150-1, such as being implemented as part of the one or more processors 152. The control module 150-1 may be implemented also as an integrated circuit or through other hardware such as a programmable gate array. In another example, the control module 150 may be implemented as control module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the control module 150 may be distributed, such as being distributed between the DU 195 and the CU 196, or be implemented solely in the DU 195.

The one or more network interfaces 161 communicate over a network such as via the links 176 and 131. Two or more RAN nodes 170 communicate using, e.g., link 176. The link 176 may be wired or wireless or both and may implement, e.g., an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, e.g., fiber optic cable or other suitable network connection to connect the other elements (e.g., a central unit (CU), gNB-CU) of the RAN node 170 to the RRH/DU 195. Reference 198 also indicates those suitable network link(s).

FIG. 1 uses the RRH/DU 195 as one possibility. It is noted that the terms RRHs (Remote Radio Heads), TRPs (Transmission Reception Points), APs (Access Points), and Radio Units (RUs) may be considered to have the same meaning in this document. Thus, the RRH/DU 195 may also be a TRP or AP.

It is noted that description herein indicates that “cells” perform functions, but it should be clear that the base station that forms the cell will perform the functions. The cell makes up part of a base station. That is, there can be multiple cells per base station. For instance, there could be three cells for a single carrier frequency and associated bandwidth, each cell covering one-third of a 360-degree area so that the single base station's coverage area covers an approximate oval or circle. Furthermore, each cell can correspond to a single carrier and a base station may use multiple carriers. So, if there are three 120-degree cells per carrier and two carriers, then the base station has a total of 6 cells.

The wireless network 100 may include a network element or elements 190 that may include core network functionality, and which provides connectivity via a link or links 181 with a data network 191, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity) functionality and/or SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general-purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones (such as smart phones, mobile phones, cellular phones, voice over Internet Protocol (IP) (VOIP) phones, and/or wireless local loop phones), tablets, customer premises equipment (CPE), portable computers, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. That is, the UE 110 could be any end device that may be capable of wireless communication. By way of example rather than limitation, the UE may also be referred to as a communication device, terminal device (MT), a Subscriber Station (SS), a Portable Subscriber Station, a Mobile Station (MS), or an Access Terminal (AT).

Having thus introduced one suitable but non-limiting technical context for the practice of the exemplary embodiments, the exemplary embodiments will now be described with greater specificity.

As described above, basic deployment scenarios have been agreed upon for HST deployments using higher frequencies, and these include, among others, e.g., a unidirectional deployment where the gNBs are located along the train track with the downlink beams pointing in one direction either towards or away from the train movement direction. A common understanding is that each gNB will have multiple Remote Radio Heads (RRH) connected for cost-optimized deployments.

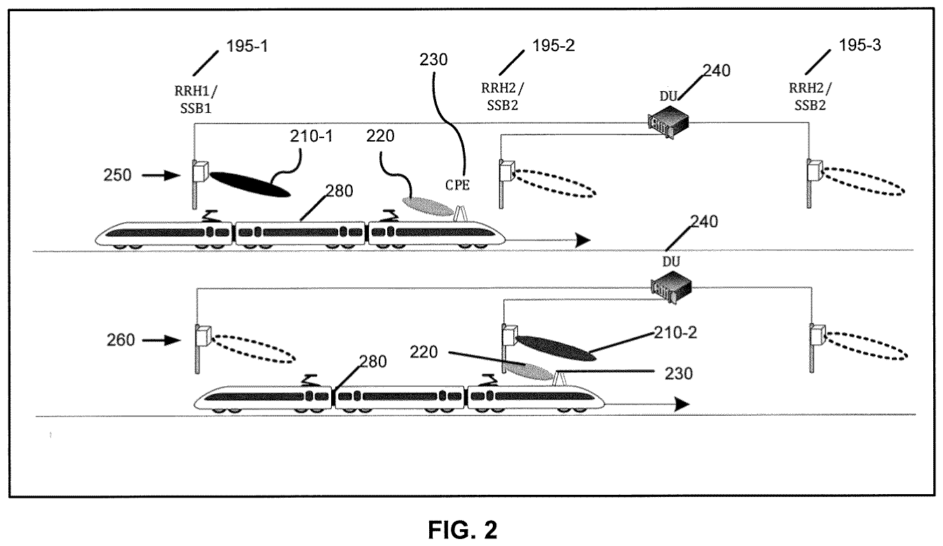

One example of a deployment scenario is shown in FIG. 2, which is an illustration of a unidirectional FR2 HST scenario, where the RRH DL beam is pointing along (same direction as) the train movement direction.

In FIG. 2, there are three RRHs: RRH1 195-1 using SSB1; RRH2 195-2 using SSB2; and RRH3 195-3 using SSB3. Each of the RRHs 195 are connected to a DU 240. The train 280 is shown in two different positions in references 250 and 260. In the first position 250, the RRH1 produces beam 210-1, and the CPE 230 (i.e., a UE 110) produces a beam 220. In the second position 260, the RRH2 produces beam 210-2, and the CPE 230 (i.e., a UE 110) still produces the beam 220. The train-mounted device (Customer Premises Equipment (CPE) 230, or similar type of device, considered to be a User Equipment (UE) 110, has one or more receiving (Rx) beams 210 that can be directed towards the gNB/RRH.

As can be recognized, once the UE moves from one cell to the next, the UE would need to be handed over (HO) to the following cell, just as it is known from baseline non-HST New Radio (NR) mobility and in legacy systems like, e.g., Long Term Evolution (LTE). However, in NR FR2, it is also a common understanding that both the UE and network will make use of beamforming to optimize the link budget and the overall performance like, e.g., throughput (TP).

Switching among different DL and/or UL beams can be performed by Radio Resource Control (RRC), Medium Access Control (MAC) and/or Downlink Control Information (DCI). After a clearly defined minimum delay, the UE shall be able to operate in the newly assigned beam. Hence, either be able to receive or transmit data.

Switching between different beams (DL, UL or both) is performed not by HO but instead by a Beam Management (BM) procedure (beam switching), which is different from HO. BM is done either by RRC, MAC and/or DCI. Common for all beam switching procedures is that they do not include Random Access (RA) in the target beam as, e.g., HO does in the target cell.

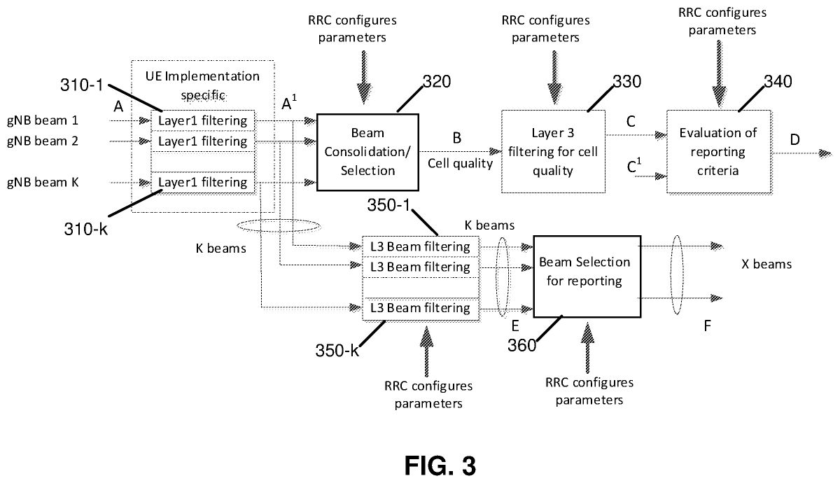

Following 3GPP TS 38.300, filtering of measurements can take place at two different levels: at the physical layer to derive beam quality; and then at the RRC level to derive cell quality from multiple beams. Measurement reports may contain the measurement results of the X best beams if the UE is configured to do so by the gNB. See FIG. 3, which illustrates an L3 mobility measurement model. This figure is a modified version of a figure in 3GPP TS 38.300. There are k gNB beams, each one directed to corresponding layer 1 filtering 310-1 through 310-k, which are UE implementation specific and applied to a beam consolidation/selection module 320. The beam consolidation/selection module 320 produces cell quality, which is input to layer 3 filtering 330 for cell quality, which has an output. This output is input to an evaluation of reporting criteria module 340, which produces a single output. The k beams after filtering are also filtered by corresponding L3 beam filters 350-1 to 350-k, and the twice-filtered beams are input to a beam selecting for reporting module 360, which outputs X beams for reporting. The RRC configures parameters in blocks 320, 330, 340, 350, and 360.

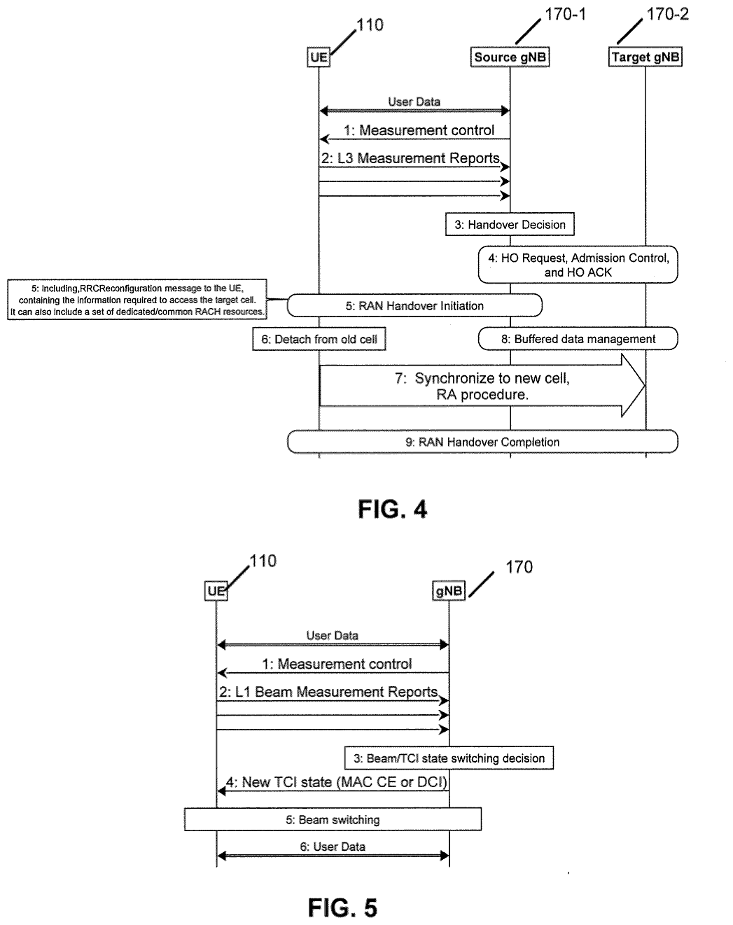

Basically, one procedure, HO, is an L3 procedure, while the other procedure, BM, is more an L1 procedure (although RRC can be used to signal the beam switch). HO is based on L3 measurements and L3 reporting, while BM is managed by L1 measurements and L1 reporting. Both procedures are illustrated on a high level in the following FIG. 4 and FIG. 5.

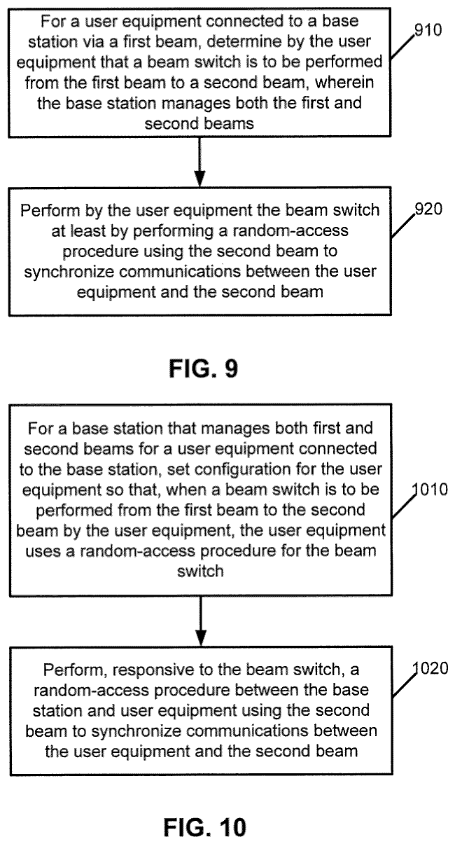

FIG. 4 is a signaling diagram for a scheme of RAN HO procedure, and this is based on FIG. 9.2.3.2.1-1: Intra-AMF/UPF Handover in 3GPP TS 38.300. There is a UE 110, and source and target gNBs 170-1, 170-2, respectively. User data is exchanged first, then the source gNB 170-1 sends (step 1) a measurement control message to the UE 110. The UE 110 responds in step 2 with a number of L3 measurement reports. The source gNB 170-1 makes a handover decision (step 3) and performs (step 4) with target gNB 170-2 a HO process by sending a HO request, participating in admission control, and receiving a HO ACK (acknowledge) from the target gNB 170-2.

The UE 110 and the source gNB 170-1 perform (step 5) a RAN handover initiation, including RRCReconfiguration message to the UE, containing the information required to access the target call. This can also include a set of dedicated/common RACH resources. In step 6, the UE 110 detaches from the old cell, and in step 7, the UE 110 synchronizes to the new cell, using an RA procedure. In step 8, the source and target gNBs participate in buffered data management, and in step 9, there is a RAN handover completion step.

For FIG. 5, which illustrates a scheme of beam/TCI state switching procedure, this starts with user data transfer between a UE 110 and a gNB 170. The first two steps are the same as in FIG. 4. In step 3, the gNB 170 makes a beam/TCI state switching decision. The gNB 170 sends a new TCI state (either MAC CE or DCI) in step 4. Beam switching is performed in step 5, and user data transfer is again performed in step 6, using the new beam.

It is clear that one of the differences between the procedures in FIGS. 4 and 5 is the use or lack of an RA procedure in the target after the change:
1) HO uses RA procedure in the target cell; and
2) BM is not using RA in the target beam after switch.

Beam switching is designed to enable fast switching between different beams mostly in FR2. NR is designed to support cells with up to 64 DL beams in one cell, and hence any additional delay in switching between the beams will impact the overall TP.

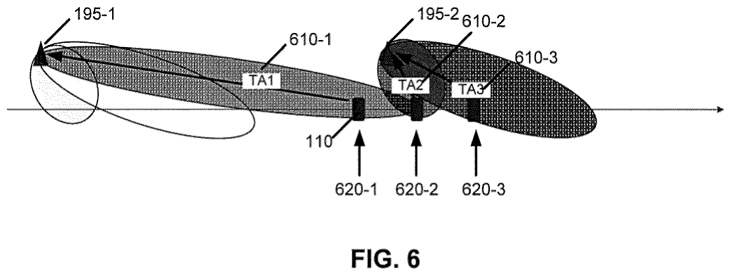

As can be recognized from FIG. 2, in the agreed FR2 HST scenario, the UE may have to switch from a beam managed by one RRH (RRH1), which is far away, to a new beam managed by another RRH (RRH2) which is close by. Going further into the details, including how to handle the UE UL synchronization (Timing Advance), TA, consider FIG. 6, which provides an illustration of the HST FR2 scenario with timing advance, where consecutive UE positions 620-1, 620-2, and 620-3, and corresponding TAs 610-1, 610-2, and 610-3 are shown.

In FIG. 6, it can be recognized that once the UE 110 reaches a point where a beam switches from RRH1 195-1 with TA1 610-1 being use to the next RRH2 195-2 DL beam, where TA2 610-2 would be needed, it can be recognized that the UE switches from being managed by a RRH 195-1 far away to a RRH 195-2 close by the UE. Thereby, there can be a significant change in the DL propagation delay and hence in the UE DL reception timing which directly impacts the UE UL transmission as well. In essence, in order to operate successfully in RRH2 610-2, the UE will have to use a new updated TA value when the beam is switched between RRH1 and RRH2.

However, in the current NR design, it is not possible to update the TA value when UE changes beams. There has been some discussion in RAN4 and elsewhere how to address this problem. However, no agreement has been reached yet. Additionally, some concerns have been raised regarding additional signaling and potential additional UE procedures.

There is, therefore, a need for defining a method that can address these concerns and provide a solution that enables TA updating at beam switch with minor additional impact.

Exemplary embodiments herein address these and other issues. Exemplary embodiments contain different methods which can be applied as stand alone or in a combined manner to provide a step-wise improved solution.

In an example, a method contains:
1) a specified method, which provides an optimized network and a UE solution; or
2) a network method, which is less optimized but has other benefits.

Examples of the specified method include the following. When the UE is in a HST scenario/cell (which is indicated explicitly by the network or can be inferred by the UE by some other means or features) the UE might always trigger random access (RA) when performing a beam switch (hence, following a network-controlled beam switch the UE will perform RA). In one alternative, the network can indicate to the UE if the UE shall always initiate RA following a beam switch or not.

In one aspect, the RA could be initiated based on link recovery, which would be triggered/initiated based on observed DL Received Time Difference (RTD) between the source and target beams. That is, the RTD is larger than a threshold. Hence, performing the RA following a beam switch would be conditioned that the DL propagation delay (e.g., observed RTD) between source and target beam exceeds a threshold (provided a UE is configured to do so or this is specified as being the UE behavior).

This behavior could be based on UE observation and would in one example, be allowed by the UE based on a network indication. In one example, such indication could be FR2 HST scenario while there could also be other explicit indications. In one example, no network indication is needed, but the behavior would be based on UE observed RTD and threshold.

In one alternative, the RA is performed when (conditioned that) the target beam is indicated as being not collocated (e.g., in FR2, QCL type-D) with source beam.

In one alternative, the RA is triggered through Beam Failure Detection (BFD) and/or Link Recovery potentially with a new cause value. Hence, when UE has determined that the UE shall initiate RA in the target beam (as described above), the UE will be using the existing link recovery procedure (using the indicated beam as a selected target—hence, not using q1 set candidates for link recovery). The q1 set is a set that contains the downlink reference signal (RS) of link recovery candidates.

Examples of the network implementation method include the following. In one example, a network implementation method that would need no new UE implementation or support is considered. It relies on network parameters and deployment knowledge and on existing network and UE procedures. The method should lead to the desired result of having UE access the target beam with RA to ensure correct update of TA after beam switch.

The method may be based on the network configuring the UE with correct downlink reference q0 for evaluating the DL radio link quality for link recovery (Beam Failure Detection (BFD)). Additionally, the network can configure the UE with the correct q1 set which contains the downlink reference signal (RS) of the link recovery candidates.

With respect to q0 and q1, following 3GPP TS 38.133 and TS 38.213, a UE can be provided, for each BWP of a serving cell, a set q0 of periodic CSI-RS resource configuration indexes and/or SSBs to detect beam failure (BF). The UE assesses the DL radio link quality of a serving cell based on the reference signals in the set q0. q1 is also a set of periodic CSI-RS resource configuration indexes and/or SS/PBCH block indexes provided to the UE, which are used by the UE for candidate beam detection after the beam failure, i.e., during link recovery.

In examples herein, once the UE triggers a link recovery (based on q0, which, e.g., would only contain the current source beam), the UE will trigger link recovery based on the indicated (e.g., configured) beam/link recovery candidates based on q1 (where q1 would, e.g., only contain the DL RS for the target beam). Link recovery includes a random-access procedure and the network may configure a dedicated preamble allowing contention-free RA for reducing the beam switch time/link recovery procedure.

It is noted that the emphasis herein is on the HST scenario. It is expected, however, that the exemplary techniques will have broader applicability. For instance, the techniques may be used in a highway scenario. Highspeed movement may not always be the main distinguishing factor here, though. Instead, deterministic mobility may be of importance. Other situations may include, in addition to the highway scenarios, avenues inside a city, paths within a large manufacturing facility, UAV (unmanned aerial vehicle) routs, and the like.

Now that an overview has been provided, additional details are provided.

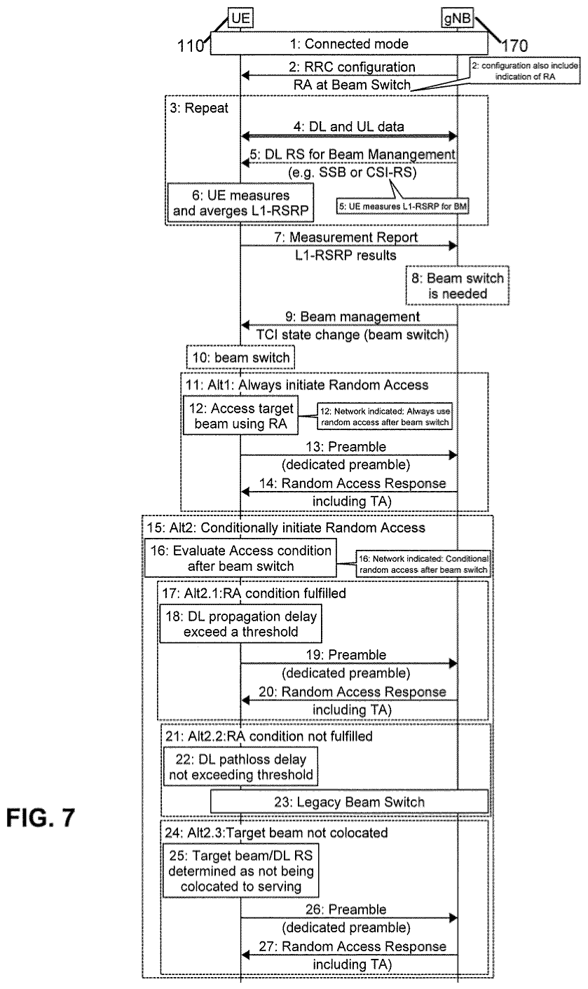

Implementation details for the specified method include the following. In the following example description is based on and refers to illustration in FIG. 7, which is a signaling diagram and flowchart for UL synchronization recovery at beam change for a specified method, in accordance with an exemplary embodiment. This figure illustrates the operation of an exemplary method, a result of execution of computer program instructions embodied on a computer readable memory, functions performed by logic implemented in hardware, and/or interconnected means for performing functions in accordance with exemplary embodiments. The corresponding operations in FIG. 7 are performed by the UE 110 under control of the control module 140, and by the gNB 170 under control of the control module 150.

As mentioned, FR2 HST is used as an example use case scenario, although the method is not generally limited to this scenario. The UE is in this example in connected mode (step 1) and has been configured by the network e.g., in an RRC configuration, with relevant information concerning (1) UE shall (e.g., always) use Random Access (RA) at beam change and (2) the potential conditions when to use the UE shall use RA in the target beam after a beam switch. This configuring is performed in step 2, where the configuration also includes an indication of RA.

In block number 3, the steps may be repeated. The UE is in active UL/DL data transmission (step 4, as one example) and performing the necessary Beam Management (BM) related measurements as configured. This is illustrated by the DL RS for beam management in step 5 and may be SSB or CSI-RS. The UE may also measure L1-RSRP for BM. The UE measures and averages (step 6) BM related measurements (here L1-RSRP) according to the UE requirements.

The UE reports the results to the network as required (step 7), including the L1-RSRP results. In block number 8, the network decides, e.g., based on the UE BM measurement report (step 7) that a beam change/switch (e.g., TCI state update) is needed. In step 9, the network requests the UE to change the beam. In step 10, the UE executes the beam switch according to the network command.

A number of alternatives are possible. Consider the following.

Alternative 1: The UE is required to access the target using RA always. See step 11. In this alternative, once the UE has switched to the target beam (step 10) the UE in step 12 accounts for the network configuration indicating that the UE shall always access the target beam, by using RA after the beam switch. In this case, after the UE has switched to the target beam, the UE transmits (step 13) a preamble to the network. The RA can in one example be based on existing random-access procedure with or without a dedicated (pre-allocated) preamble. Based on the received preamble on the network side, the network estimates the TA to be used by the UE and signals in step 14 the TA value to the UE (e.g., in the Random-Access Response (RAR) message).

Concerning the existing random-access procedure with or without a dedicated (pre-allocated) preamble, in general, there are two types of random-access procedures: a contention-based random-access (CBRA) procedure; and a contention-free random-access (CFRA) procedure. In the CBRA procedure, multiple users randomly select a preamble from a pool of preambles, and a contention resolution phase determines which user, if any, had its data successfully received by the network. Contention resolution resolves contention between two or more users selecting the same preamble. In the CFRA procedure, a preamble is uniquely pre-allocated to the user, hence there is no possibility of preamble collision between users and no need for contention resolution, and such RA procedure is executed faster.

In CFRA, the preamble assignment is predetermined by the network. The preamble assignment determines:
1) The preamble index.
2) The mask index to determine the PRACH Occasion(s) to use for preamble transmission within the set of PRACH occasions associated with the SS/PBCH.
3) Block or the channel-state information reference signals (CSI-RS) used for preamble transmission.

The UE transmits on a preassigned preamble index and PRACH occasion(s) associated with a reference signal (e.g., SS/PBCH block or CSI-RS) that exceeds a higher layer configured threshold, e.g., rsrp-ThresholdSSB or rsrp-ThresholdCSI-RS. As the preamble is preassigned by the network, there is no contention resolution phase. The random-access procedure is considered successful after reception of a RAR with a RAPID that matches the transmitted preamble.

Alternative 2: UE is required to access target using RA if condition(s) are fulfilled. See block 15. In this alternative, once the UE has switched to the target beam (step 10) the UE in step 16 accounts for the network configuration indicating that UE shall access the target beam if (configured) conditions are fulfilled. That is, the UE evaluates the access condition(s) after the beam switch. In one alternative, the conditions could be defined directly in the specifications and would therefore not necessarily need to be configured.

In Alternative 2.1, the UE has been configured with a condition stating that if the DL pathloss delay between the source and target cell exceeds a certain threshold, the UE shall access the target using RA (block number 17). Otherwise, the UE will not access the target beam using RA but behave using legacy operations, and the UE can be scheduled and can transmit once the beam switch is done (block number 21).

In block 17, the UE determines in step 18 that a DL propagation delay exceeds a threshold (the RA condition is fulfilled), and in response, sends (step 19) a preamble (e.g., a dedicated preamble) to the gNB 170. The gNB 170 responds (step 20) with a RAR, including TA.

In one example, the DL received time difference threshold could be equal to the largest allowed one-step UE autonomous TA adjustment, Tq as defined in 3GPP TS 38.133.

The RA can, in one example, be based on existing RA procedure with or without a dedicated (pre-allocated) preamble. Based on the received preamble, the network estimates the TA to be used by the UE and signals in step 14 the TA value to the UE (e.g., in the Random-Access Response (RAR) message).

In Alternative 2.2 (step 21), the UE may be configured with a condition stating that if the target beam is indicated as not being collocated with the source beam, the UE shall access the target using RA (block 24). By collocated/non-collocated, what is meant is geographical location of the beam source, i.e., RRH in these examples. Collocated means at a geographical location (e.g., within some threshold distance), whereas non-collocated means at different geographical locations (e.g., outside that threshold distance). Otherwise, the UE will not access the target beam using RA but behave using a legacy process (see step 23), and the UE can be scheduled and can transmit once the beam switch is done (not illustrated).

In block 21, the UE determines in step 22 that a DL propagation delay does not exceed the threshold (the RA condition is not fulfilled), and the UE and gNB coordinate in step 23 to perform a legacy beam switch process.

In block 24, Alternative 2.3 is performed, where a target beam is not collocated. In step 25, the UE determines the target beam/DL RS is determined as not being collocated to the serving beam. In step 26, the UE sends a preamble (e.g., a dedicated preamble) to the gNB, which responds (step 27) with a RAR, including TA.

The RA can in one example be based on existing random-access procedures with or without a dedicated (pre-allocated) preamble. Based on the received preamble on the network side, the network estimates the TA to be used by the UE and signals in step 14 the TA value to the UE (e.g., in the Random-Access Response (RAR) message).

Combinations of the above options are possible.

Implementation details for the network implementation method include the following. This method is a network method in which the network configures the UE in such a way that the UE will access the target beam using RA, e.g., in terms of the Beam Failure Recovery (BFR) procedure. In the simplest approach, there is no need for any additional UE support beyond which may already be implemented. However, the method can be improved by defining that the UE shall access the target beam with a known dedicated RA preamble (which then benefits from additional change to the specification and minor additions in the UE and network). In the following, focus is placed on method implementation without any specification changes.

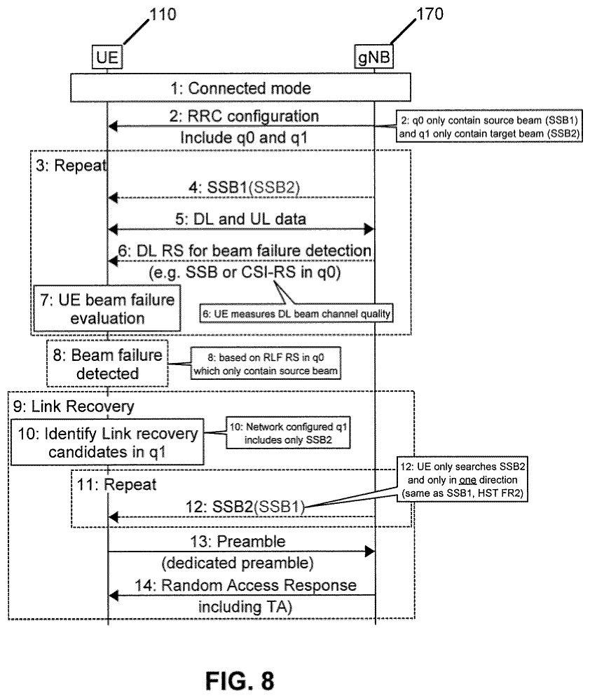

The basic method description is based on the illustration in FIG. 8, which is a signaling diagram and flowchart for UL synchronization recovery at beam change for a network implementation method, in accordance with an exemplary embodiment. This figure illustrates the operation of an exemplary method, a result of execution of computer program instructions embodied on a computer readable memory, functions performed by logic implemented in hardware, and/or interconnected means for performing functions in accordance with exemplary embodiments. The corresponding operations in FIG. 8 are performed by the UE 110 under control of the control module 140, and by the gNB 170 under control of the control module 150.

Initially, the UE is in connected mode (step 1) and is configured (step 2) by the network with Beam Failure Detection Reference Signals (BFD-RS) set q0. This set will only contain the BFD RS of the serving DL beam. In one example, it would be the SSB1. Additionally, the network will configure the UE with a candidate beam detection/link recovery RS set, q1. This RS set will only contain the DL beam RSs of the target beam (or of a few closest beams). In FIG. 8, it is shown as SSB2. In HST deployments, it is expected that only one beam will be needed in most cases. The techniques are, however, not limited to one and a few beams, such as three beams, may be enough in any other scenario as well.

Block 3 has a number of operations that may repeat. Based on such configuration, if the UE detects beam failure (steps 4-8), the UE will initiate link recovery on using the set q1 (block number 9). In a deployment with a deterministic UE mobility, like the FR2 HST, where it is predictable which will be the next target beam (based on the source beam), it is efficient and sufficient to configure the UE only to search the predictable target in link recovery set q1.

In step 4, the gNB 170 sends an SSB1 to the UE 110. There is an SSB0 also shown, as in general, the UE is measuring many SSBs, i.e., not only from the serving RRH but from all other RRHs that the UE can hear. The UE and gNB communicate DL and UL data in step 5, and in step 6, the gNB sends DL RS for beam failure detection (e.g., SSB or CSI-RA in q0). The UE measures DL channel quality also in step 6. In step 7, the UE performs a beam failure evaluation.

In step 8, the UE detects a beam failure. This may be based on RLF RS in q0, which only contains the source beam, as an example.

Block 9 has an example of a process for link recovery. In step 10, the UE 110 identifies link recovery candidates in q1, and in an example the network has configured q1, which includes only SSB2. Step 11 may be repeated, and the gNB sends (step 12) SSB2, and in an example, the UE only searches SSB2 (e.g., and also SSB1) and only in one direction (which is the same as SSB1, for HST FR2). That is, a UE/CPE may have two panels oriented into the opposite directions, i.e., the UE/CPE can receive signals from two opposite directions. If one assumes unidirectional deployment as in FIG. 2, then the UE can continue receiving with the same panel, i.e., from the same direction as SSB1, as illustrated in FIG. 2. This directionality is in reference to an orientation of the UE, e.g., the panel being (mainly) used is in reference to how the UE is positioned. This “one direction” searching may be configured for the UE 110 by the network, e.g., the gNB 170. As another alternative, the UE 110 may be able determine on its own that the DL signal is always coming only from one direction, and therefore search only in that direction. Other options are also possible.

This process is repeated until an appropriate target beam is found in q1. Especially in FR2 if the UE is indicated the deployment scenario (e.g., unidirectional, see FIG. 3), the UE can additionally optimize the searching in the expected direction of the new target beam and thereby reduce the UE sweeping delay (step 12).

Once the UE has detected the target beam based on the set q1, the UE will access the target beam using link recovery procedure (steps 13 and 14). That is, once a target beam is found, the UE in step 13 sends a preamble (e.g., a dedicated preamble) corresponding to the target beam to the gNB. The gNB response with a RAR, including TA.

Turning to FIG. 9, this figure is a logic flow diagram performed by a UE for UL synchronization recovery at beam change. This figure also illustrates the operation of an exemplary method, a result of execution of computer program instructions embodied on a computer readable memory, functions performed by logic implemented in hardware, and/or interconnected means for performing functions in accordance with an exemplary embodiment. The operations of FIG. 9 are performed by the UE 110, under control of the control module 140.

In block 910, for a user equipment connected to a base station via a first beam, the user equipment determines that a beam switch is to be performed from the first beam to a second beam. The base station manages both the first and second beams. In block 920, the user equipment performs the beam switch at least by performing a random-access procedure using the second beam to synchronize communications between the user equipment and the second beam.

The following are additional examples. In these examples, the method of FIG. 9 is referred to as example 1.

Example 2. The method of example 1, wherein the user equipment is configured to always initiate the random-access procedure for every beam switch between beams where a base station manages both beams.

Example 3. The method of example 1, wherein the user equipment is configured to initiate the random-access procedure based on one or more conditions.

Example 4. The method of example 3, wherein the user equipment is configured to initiate the random-access procedure based on the one or more conditions being fulfilled.

Example 5. The method of example 4, wherein the one or more conditions being fulfilled comprise a downlink propagation delay that exceeds a threshold.

Example 6. The method of example 3, wherein:
the performing the random-access procedure using the second beam to synchronize communications is performed based on the one or more conditions being fulfilled; and
a beam switch is performed from the first to second beam without using the random-access procedure based on the one or more conditions not being fulfilled.

Example 7. The method of example 3, wherein the one or more conditions being fulfilled comprise a determination the second beam or downlink reference signal corresponding to the second beam indicated the second beam is not collocated with the serving beam.

Example 8. The method of any one of examples 1 to 7, wherein the determining that a beam switch is to be performed and the performing the beam switch are performed in response to reception by the user equipment of an indication that the random-access procedure is to be used for any beam switch that is to be performed from the first beam to a second beam where a base station manages both the first and second beams.

Example 9. The method of example 1, wherein:
the user equipment is configured with a first set of beams containing only the first beam;
the determining by the user equipment that a beam switch is to be performed from the first beam to the second beam is in response to a reference signal for the first beam being determined to indicate a beam failure; and
the performing by the user equipment the beam switch comprises performing, because the first set contains only the first beam, the random-access procedure using the second beam based on the beam failure.

Example 10. The method of example 9, wherein:
the user equipment is configured with a second set of beams containing the second beam; and
the method further comprises identifying by the user equipment link recovery candidate beams using the second set at least by searching secondary synchronization signal corresponding to the beams in the second set, and selecting the second cell based on the search.

Example 11. The method of example 10, wherein the searching secondary synchronization signal corresponding to the beams in the second set is performed in one direction relative to the orientation of the user equipment.

Example 12. The method of example 10 or 11, wherein the second set contains a few beams, of which one is the second beam, and the base station manages the few beams.

Referring to FIG. 10, this is a logic flow diagram performed by a base station for UL synchronization recovery at beam change. FIG. 10 illustrates the operation of an exemplary method, a result of execution of computer program instructions embodied on a computer readable memory, functions performed by logic implemented in hardware, and/or interconnected means for performing functions in accordance with an exemplary embodiment. The operations of FIG. 10 are performed by a base station, such as a gNB 170, under control of the control module 150.

In block 1010, for a base station that manages both first and second beams for a user equipment connected to the base station, the base station sets configuration for the user equipment so that, when a beam switch is to be performed from the first beam to the second beam by the user equipment, the user equipment uses a random-access procedure for the beam switch. In block 1020, the base station performs, responsive to the beam switch, a random-access procedure between the base station and user equipment using the second beam to synchronize communications between the user equipment and the second beam.

In the following examples, the flowchart of FIG. 10 is referred to as example 13.

Example 14. The method of example 13, wherein the configuration is to always initiate by the user equipment the random-access procedure for every beam switch between beams where a base station manages both beams.

Example 15. The method of example 13, wherein the configuration is to initiate by the user equipment the random-access procedure based on one or more conditions.

Example 16. The method of example 15, wherein the configuration is to initiate by the user equipment the random-access procedure based on the one or more conditions being fulfilled.

Example 17. The method of example 16, wherein the one or more conditions being fulfilled comprise a downlink propagation delay that exceeds a threshold.

Example 18. The method of example 15, wherein:
the performing the random-access procedure using the second beam to synchronize communication is performed based on the one or more conditions being fulfilled; and
the configuration is to cause by the user equipment a beam switch to be performed from the first to second beam without using the random-access procedure based on the one or more conditions not being fulfilled.

Example 19. The method of example 15, wherein the one or more conditions being fulfilled comprise a determination the second beam or downlink reference signal corresponding to the second beam indicated the second beam is not collocated with the serving beam.

Example 20. The method of any one of examples 13 to 19, wherein the configuration comprises the random-access procedure is to be used by the user equipment for any beam switch that is to be performed from the first beam to a second beam where the base station manages both the first and second beams.

Example 21. The method of example 13, wherein:
the configuration configures the user equipment with a first set of beams containing only the first beam such that, because the first set contains only the first beam, the user equipment will determine the beam switch has to be performed to the second beam based on a determination of beam failure for the first beam.

Example 22. The method of example 21, wherein:
the configuration configures the user equipment with a second set of beams containing the second beam.

Example 23. The method of example 22, wherein the configuration configures the user equipment to search secondary synchronization signals corresponding to the beams in the second set in one direction relative to the orientation of the user equipment and wherein the base station transmits synchronization signals on the second beam.

Example 24. The method of example 22 or 23, wherein the second set contains a few beams, of which one is the second beam, and wherein the base station transmits synchronization signals on the few beams.

Example 25. A computer program, comprising code for performing the methods of any of examples 1 to 24, when the computer program is run on a computer.

Example 26. The computer program according to example 25, wherein the computer program is a computer program product comprising a computer-readable medium bearing computer program code embodied therein for use with the computer.

Example 27. The computer program according to example 25, wherein the computer program is directly loadable into an internal memory of the computer.

Example 28. An apparatus, comprising means for performing:
for a user equipment connected to a base station via a first beam, determining by the user equipment that a beam switch is to be performed from the first beam to a second beam, wherein the base station manages both the first and second beams; and
performing by the user equipment the beam switch at least by performing a random-access procedure using the second beam to synchronize communications between the user equipment and the second beam.

Example 29. The apparatus of example 28, wherein the user equipment is configured to always initiate the random-access procedure for every beam switch between beams where a base station manages both beams.

Example 30. The apparatus of example 28, wherein the user equipment is configured to initiate the random-access procedure based on one or more conditions.

Example 31. The apparatus of example 29, wherein the user equipment is configured to initiate the random-access procedure based on the one or more conditions being fulfilled.

Example 32. The apparatus of example 30, wherein the one or more conditions being fulfilled comprise a downlink propagation delay that exceeds a threshold.

Example 33. The apparatus of example 29, wherein:
the performing the random-access procedure using the second beam to synchronize communications is performed based on the one or more conditions being fulfilled; and
a beam switch is performed from the first to second beam without using the random-access procedure based on the one or more conditions not being fulfilled.

Example 34. The apparatus of example 29, wherein the one or more conditions being fulfilled comprise a determination the second beam or downlink reference signal corresponding to the second beam indicated the second beam is not collocated with the serving beam.

Example 35. The apparatus of any one of examples 28 to 34, wherein the determining that a beam switch is to be performed and the performing the beam switch are performed in response to reception by the user equipment of an indication that the random-access procedure is to be used for any beam switch that is to be performed from the first beam to a second beam where a base station manages both the first and second beams.

Example 36. The apparatus of example 28, wherein:
the user equipment is configured with a first set of beams containing only the first beam;
the determining by the user equipment that a beam switch is to be performed from the first beam to the second beam is in response to a reference signal for the first beam being determined to indicate a beam failure; and
the performing by the user equipment the beam switch comprises performing, because the first set contains only the first beam, the random-access procedure using the second beam based on the beam failure.

Example 37. The apparatus of example 36, wherein:
the user equipment is configured with a second set of beams containing the second beam; and
the means are further configured to perform identifying by the user equipment link recovery candidate beams using the second set at least by searching secondary synchronization signal corresponding to the beams in the second set, and selecting the second cell based on the search.

Example 38. The apparatus of example 37, wherein the searching secondary synchronization signal corresponding to the beams in the second set is performed in one direction relative to the orientation of the user equipment.

Example 39. The apparatus of example 37 or 38, wherein the second set contains a few beams, of which one is the second beam, and the base station manages the few beams.

Example 40. An apparatus, comprising means for performing:
for a base station that manages both first and second beams for a user equipment connected to the base station, setting configuration for the user equipment so that, when a beam switch is to be performed from the first beam to the second beam by the user equipment, the user equipment uses a random-access procedure for the beam switch; and
performing, responsive to the beam switch, a random-access procedure between the base station and user equipment using the second beam to synchronize communications between the user equipment and the second beam.

Example 41. The apparatus of example 40, wherein the configuration is to always initiate by the user equipment the random-access procedure for every beam switch between beams where a base station manages both beams.

Example 42. The apparatus of example 40, wherein the configuration is to initiate by the user equipment the random-access procedure based on one or more conditions.

Example 43. The apparatus of example 42, wherein the configuration is to initiate by the user equipment the random-access procedure based on the one or more conditions being fulfilled.

Example 44. The apparatus of example 43, wherein the one or more conditions being fulfilled comprise a downlink propagation delay that exceeds a threshold.

Example 45. The apparatus of example 42, wherein:
the performing the random-access procedure using the second beam to synchronize communication is performed based on the one or more conditions being fulfilled; and
the configuration is to cause by the user equipment a beam switch to be performed from the first to second beam without using the random-access procedure based on the one or more conditions not being fulfilled.

Example 46. The apparatus of example 42, wherein the one or more conditions being fulfilled comprise a determination the second beam or downlink reference signal corresponding to the second beam indicated the second beam is not collocated with the serving beam.

Example 47. The apparatus of any one of examples 40 to 46, wherein the configuration comprises the random-access procedure is to be used by the user equipment for any beam switch that is to be performed from the first beam to a second beam where the base station manages both the first and second beams.

Example 48. The apparatus of example 40, wherein:
the configuration configures the user equipment with a first set of beams containing only the first beam such that, because the first set contains only the first beam, the user equipment will determine the beam switch has to be performed to the second beam based on a determination of beam failure for the first beam.

Example 49. The apparatus of example 48, wherein:
the configuration configures the user equipment with a second set of beams containing the second beam.

Example 50. The apparatus of example 49, wherein the configuration configures the user equipment to search secondary synchronization signals corresponding to the beams in the second set in one direction relative to the orientation of the user equipment and wherein the base station transmits synchronization signals on the second beam.

Example 51. The apparatus of example 49 or 50, wherein the second set contains a few beams, of which one is the second beam, and wherein the base station transmits synchronization signals on the few beams.

Example 52. The apparatus of any preceding apparatus example, wherein the means comprises:
at least one processor; and
at least one memory including computer program code, the at least one memory and computer program code configured to, with the at least one processor, cause the performance of the apparatus.

Example 53. An apparatus, comprising:
one or more processors; and
one or more memories including computer program code,
wherein the one or more memories and the computer program code are configured, with the one or more processors, to cause the apparatus to:
for a user equipment connected to a base station via a first beam, determine by the user equipment that a beam switch is to be performed from the first beam to a second beam, wherein the base station manages both the first and second beams; and
perform by the user equipment the beam switch at least by performing a random-access procedure using the second beam to synchronize communications between the user equipment and the second beam.

Example 54. An apparatus, comprising:
one or more processors; and
one or more memories including computer program code,
wherein the one or more memories and the computer program code are configured, with the one or more processors, to cause the apparatus to:
for a base station that manages both first and second beams for a user equipment connected to the base station, set configuration for the user equipment so that, when a beam switch is to be performed from the first beam to the second beam by the user equipment, the user equipment uses a random-access procedure for the beam switch; and
perform, responsive to the beam switch, a random-access procedure between the base station and user equipment using the second beam to synchronize communications between the user equipment and the second beam.

Example 55. A computer program product comprising a computer-readable storage medium bearing computer program code embodied therein for use with a computer, the computer program code comprising:
for a user equipment connected to a base station via a first beam, determining by the user equipment that a beam switch is to be performed from the first beam to a second beam, wherein the base station manages both the first and second beams; and
performing by the user equipment the beam switch at least by performing a random-access procedure using the second beam to synchronize communications between the user equipment and the second beam.

Example 56. A computer program product comprising a computer-readable storage medium bearing computer program code embodied therein for use with a computer, the computer program code comprising:
for a base station that manages both first and second beams for a user equipment connected to the base station, setting configuration for the user equipment so that, when a beam switch is to be performed from the first beam to the second beam by the user equipment, the user equipment uses a random-access procedure for the beam switch; and
performing, responsive to the beam switch, a random-access procedure between the base station and user equipment using the second beam to synchronize communications between the user equipment and the second beam.

Without in any way limiting the scope, interpretation, or application of the claims appearing below, a technical effect and advantage of one or more of the example embodiments disclosed herein is the embodiments resolve the problem of incorrect timing of UL transmissions after non-collocated beam switching. Therefore, the considerable temporary degradation of UL connection quality is avoided. Another technical effect and advantage of one or more of the example embodiments disclosed herein is the proposed mechanism is still network-control based. Therefore, it is agnostic to the network and follows existing RAN4 requirements. Another technical effect and advantage of one or more of the example embodiments disclosed herein is the interruption time (i.e., the time from the start of beam switch and to the moment when UE can transmit in UL again) is minimized, e.g., due to the use of RA with pre-allocated resources and restricting q1 set of candidate beams according to the deployment.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes example embodiments of the invention, these descriptions should not be viewed in a limiting sense. Rather, there are several variations and modifications which may be made without departing from the scope of the present invention.

The following abbreviations that may be found in the specification and/or the drawing figures are defined as follows:
3GPP third generation partnership project
5G fifth generation
5GC 5G core network
AMF access and mobility management function
BF beam failure
BFD beam failure detection
BFR beam failure recovery
BM beam management
BWP bandwidth part
CE control element
CPE customer premises equipment
CSI channel state information
CU central unit
DCI downlink control information
DL downlink (from the network to the UE)
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FR2 frequency range 2
gNB (or gNodeB) base station for 5G/NR, i.e., a node providing NR user plane and control plane protocol terminations towards the UE, and connected via the NG interface to the 5GC
HO handover
HST high-speed train
I/F interface
LTE long term evolution
MAC medium access control
MME mobility management entity
ng or NG next generation
ng-eNB or NG-eNB next generation eNB
NR new radio
N/W or NW network
PBCH physical broadcast channel
PDCP packet data convergence protocol
PHY physical layer
PRACH physical random-access channel
QCL quasi co-location
RA random access
RAN radio access network
Rel release
RLC radio link control
RLF radio link failure
RRH remote radio head
RRC radio resource control
RS reference signal
RSRP reference signal received power
RTD round-trip delay
RU radio unit
Rx receiver or reception
SDAP service data adaptation protocol
SGW serving gateway
SMF session management function
SS synchronization signal
SSB secondary synchronization signal
TA timing advance
TCI transmission configuration indication
TP throughput
TS technical specification
Tx transmitter or transmission
UE user equipment (e.g., a wireless, typically mobile device)
UL uplink (from the user equipment to the network)
UPF user plane function

1-17. (canceled)

18. A method for a user equipment connected to a base station via a first beam, comprising:
determining that a beam switch is to be performed from the first beam to a second beam, wherein the base station manages both the first and second beams; and
performing the beam switch at least by performing a random-access procedure using the second beam to synchronize communications between the user equipment and the second beam.

19. The method of claim 18, wherein the user equipment is configured to always initiate the random-access procedure for every beam switch between beams where a base station manages both beams.

20. The method of claim 18, wherein the user equipment is configured to initiate the random-access procedure based on one or more conditions.

21. The method of claim 18, wherein:
the performing the random-access procedure using the second beam to synchronize communications is performed based on the one or more conditions being fulfilled; and
a beam switch is performed from the first to second beam without using the random-access procedure based on the one or more conditions not being fulfilled.

22. The method of claim 20, wherein the one or more conditions being fulfilled comprise a determination the second beam or downlink reference signal corresponding to the second beam indicated the second beam is not collocated with the serving beam.

23. The method of claim 18, wherein the determining that a beam switch is to be performed and the performing of the beam switch are performed in response to reception by the user equipment of an indication that the random-access procedure is to be used for any beam switch that is to be performed from the first beam to a second beam where a base station manages both the first and second beams.

24. The method of claim 18, wherein:
the user equipment is configured with a first set of beams containing only the first beam;
the determining by the user equipment that a beam switch is to be performed from the first beam to the second beam is in response to a reference signal for the first beam being determined to indicate a beam failure; and
the performing by the user equipment of the beam switch comprises performing, because the first set contains only the first beam, the random-access procedure using the second beam based on the beam failure.

25. The method of claim 18, wherein:
the user equipment is configured with a second set of beams containing the second beam; and
the user equipment identifies link recovery candidate beams using the second set at least by searching a secondary synchronization signal corresponding to the beams in the second set, and selecting the second cell based on the search.

26. The method of claim 25, wherein: the searching of the secondary synchronization signal corresponding to the beams in the second set is performed in one direction relative to the orientation of the user equipment.

27. An apparatus, comprising:
one or more processors; and one or more memories including computer program code,
wherein the one or more memories and the computer program code are configured, with the one or more processors, to cause the apparatus to:
determine for a user equipment connected to a base station via a first beam, that a beam switch is to be performed from the first beam to a second beam, wherein the base station manages both the first and second beams; and
perform for the user equipment the beam switch at least by performing a random-access procedure using the second beam to synchronize communications between the user equipment and the second beam.

28. The apparatus of claim 27, wherein the user equipment is configured to always initiate the random-access procedure for every beam switch between beams where a base station manages both beams.

29. The apparatus of claim 27, wherein the user equipment is configured to initiate the random-access procedure based on one or more conditions.

30. The apparatus of claim 27, wherein the one or more processors; and the one or more memories including computer program code, are further configured, with the one or more processors, to further cause the apparatus to:
perform the random-access procedure using the second beam to synchronize communications, based on the one or more conditions being fulfilled; and
perform a beam switch from the first to second beam without using the random-access procedure based on the one or more conditions not being fulfilled.

31. The apparatus of claim 27, wherein the one or more conditions being fulfilled comprise a determination the second beam or downlink reference signal corresponding to the second beam indicated the second beam is not collocated with the serving beam.

32. The apparatus of claim 27, wherein the user equipment is configured with a first set of beams containing only the first beam;
wherein the one or more processors; and the one or more memories including computer program code, are further configured, with the one or more processors, to further cause the apparatus to:
determine for the user equipment that a beam switch is to be performed from the first beam to the second beam, in response to a reference signal for the first beam being determined to indicate a beam failure; and
because the first set contains only the first beam, perform the random-access procedure using the second beam based on the beam failure for the beam switch.

33. The apparatus of claim 32, wherein the user equipment is configured with a second set of beams containing the second beam; and wherein the one or more processors;
and the one or more memories including computer program code, are further configured, with the one or more processors, to further cause the apparatus to:
identify for the user equipment link recovery candidate beams using the second set at least by searching a secondary synchronization signal corresponding to the beams in the second set, and select the second cell based on the search.

34. The apparatus of claim 33, wherein the one or more processors; and the one or more memories including computer program code, are further configured, with the one or more processors, to further cause the apparatus to:
perform the searching of the secondary synchronization signal corresponding to the beams in the second set, in one direction relative to the orientation of the user equipment.

35. An apparatus, comprising:
one or more processors; and one or more memories including computer program code, wherein the one or more memories and the computer program code are configured, with the one or more processors, to cause the apparatus to:
set, for a base station that manages both first and second beams for a user equipment connected to the base station, a configuration for the user equipment so that, when a beam switch is to be performed from the first beam to the second beam by the user equipment, the user equipment uses a random-access procedure for the beam switch; and
perform, in response to the beam switch, a random-access procedure between the base station and user equipment using the second beam to synchronize communications between the user equipment and the second beam.

36. The apparatus according to claim 35, wherein the one or more memories and the computer program code are further configured, with the one or more processors, to further cause the apparatus to:
configure the user equipment to always initiate the random-access procedure for every beam switch between beams where a base station manages both beams.

37. The apparatus according to claim 35, wherein the one or more memories and the computer program code are further configured, with the one or more processors, to further cause the apparatus to:
configure the user equipment to initiate the random-access procedure based on one or more conditions.
